(19) United States
(12) Patent Application Publication
(10) Pub. No.: US 2024/0411015 A1
(43) Pub. Date: Dec. 12, 2024

(54) Reversing Assistance Device and Method for Assisting a Vehicle During Reversing Operation

(71) Applicant: Knorr-Bremse Systeme für Nutzfahrzeuge GMBH, Munich (DE)

(72) Inventors: Daniel Thum, Munich (DE); Jan Grebe, Munich (DE); Tamas Komlos, Csavoly (HU)

(21) Appl. No.: 18/697,635

(22) PCT Filed: Sep. 28, 2022
(86) PCT No.: PCT/EP2022/076887

§ 371 Date: Apr. 1, 2024

(30) Foreign Application Priority Data
Oct. 6, 2021 (EP) 21201301.5

(51) Int. Cl. G01S 13/931; B60Q 9/00; B60R 11/04

(52) U.S. Cl. CPC G01S 13/931; B60Q 9/006; B60R 11/04; G01S 2013/9317; G01S 2013/93272

(57) ABSTRACT

A reversing assistance device for a vehicle is disclosed. The vehicle comprises a radar unit mounted on a rear of the vehicle and is configured to provide distance information to an object that is fully or partially behind the vehicle when approaching the object under an approaching angle. The reversing assistance device comprises an evaluation unit configured to provide a reversing support function by: obtaining from the radar unit the distance information to the object; determining, based on the distance information, a shortest longitudinal distance between a corner of the rear of the vehicle and the object along a reversing direction of the vehicle; and, based on the shortest longitudinal distance, modifying the distance information to compensate for the approaching angle.

This application is claiming priority to the National Stage filing of EP21201301.5, priority date 6 Oct. 2021, under International Application No. PCT/EP2022/076887, international filing date 28 Sep. 2022.

### BACKGROUND AND SUMMARY

The present invention relates to a reversing assistance device and a method for assisting a vehicle during the reversing operation, in particular to a method to support the driver during the reversing operation when approaching an object partially or fully behind a commercial vehicle under a non-rectangular angle.

When a driver of a long vehicle or a vehicle combination performs a reverse operation in the vicinity of an object (e.g. a loading dock or any other obstacle), it is hard to distinguish whether or not the driver is at a safe distance from the obstacle or object. In particular, if the object is not parallel to a back side of the vehicle, conventional sensors are unable to precisely measure the real closest distance along the reversing direction to the object. In such situations, the reversing maneuver mainly depends on the driver experiences and skills. Also a driving unit utilized in autonomous driving may draw wrong conclusions in such situations.

Therefore, there is a demand for a system that is able to assist the driver or a driving unit during the reversing operation.

At least some of the problems of the conventional device as described before are overcome by a device of claim 1, a control unit of claim 6, and a method according to claim 10. The dependent claims refer to further advantageous realizations of the subject matters of the independent claims.

The present invention relates to reversing assistance device (or a backup assistant) for a vehicle. The vehicle comprises a radar unit mounted on a rear of the vehicle which is configured to provide distance information to an object that is fully or partially behind the vehicle when approaching the object under an approaching angle α (which may neither be zero nor 90°). The reversing assistance device includes an evaluation unit configured to provide a reversing support function by: obtaining from the radar unit the distance information to the object; determining, based on the distance information, a shortest longitudinal distance C between a corner of the rear of the vehicle and the object along a reversing direction y of the vehicle; and based on the shortest longitudinal distance C, modifying the distance information to compensate for the approaching angle α (in particular if the approaching angle α is non-perpendicular).

The term “distance information” shall be understood broadly in that it should encompass all information sufficient for the determination of the closest distance R and the angle α without the need of directly providing these quantities. For example, the radar unit may provide coordinates of the object or multiple distances to different reflection points on the object or any other quantities that enable the calculation of the approaching angle α.

The term “object” can be understood as an object partially or fully located behind the vehicle. The object can further be understood as any obstacle on the reversing way or direction such as a loading dock, a house, a bump, a wall, a column, a pollard, another vehicle etc. The object herein may be particularly an object that is neither fully parallel to the reversing direction nor fully perpendicular to the reversing direction. The object may have any height (e.g. 10 cm or higher, 20 cm or higher).

The vehicle may, in particular, be a commercial vehicle such as a long-haul transport vehicle, a trailer, a towing vehicle, a vehicle combination etc.

The shortest longitudinal distance C is a distance between points where the vehicle and the object hit each other when the reversing continuous. Typically, it a corner of the rear of the vehicle and a point (or line) on the object. Considering that the vehicle is approaching the object under an angle α, it should be appreciated that a closest distance R measured by the radar unit may, in general, be greater than the shortest longitudinal distance C.

The radar unit may comprise at least one of the following: an antenna array, a phased array antenna, a MIMO Radar or any other means to enable the radar unit to measure not only the closest distance(s) R, but also the angle α or longitudinal and/or lateral position information from the radar unit to reflection point(s) of the return signals. The radar unit may also comprise multiple radar elements, which may be placed at different locations, each comprising a transmitter and a receiver so that multiple distances can measured. In other words, the exemplary radar unit may include multiple transmitters and receivers to enable an angular resolution for the received signals.

Optionally, the evaluation unit may thus be configured to determine and/or to transmit to other systems at least one of the following: the approaching angle α; a closest distance R between the radar unit and a reflection point on the object; a longitudinal distance F between the rear of the vehicle and the reflection point on the object measured along reversing direction y, in particular by using: F=R×sin α, wherein R is the closest distance and α the approaching angle; a lateral distance “b” between the radar unit and the reflection point measured along a lateral direction x, in particular by using: b=R×cos α, wherein R is the closest distance and α is the approaching angle; the shortest longitudinal distance C, in particular by using: C=F+(b−a)×b/F, wherein “a” is a distance from the radar unit to a rear corner of the vehicle, a compensation for an offset of a position of the radar unit from a reference position (predetermined position such as a middle or central position of the vehicle's rear). The other systems may include another control unit in the vehicle or a driving unit and may issue, upon receipt of one or more of the above information, a warning or may initiate other actions (e.g. a braking action).

Therefore, although the radar unit may be mounted at a central position or a middle position, this is not necessary. The radar unit may be mounted at any position at the rear of the vehicle and the evaluation unit may take into account the distance (offset) of the radar unit from a corner or from a middle line of the vehicle rear. Hence, according to embodiments, the evaluation unit is configured to compensate any offset in the position of the radar unit. The corresponding information about the mounting position may be stored in the radar unit or in the evaluation unit or may be obtained from any storage device in the vehicle.

The vehicle may be operated by a driver or by a driving unit and, optionally, the evaluation unit is further configured to issue a signal to the driver or the driving unit, in case the determined shortest longitudinal distance C, is shorter than a threshold (e.g. 2 meters, 1 meter or less).

Optionally, the evaluation unit is configured to issue an alert signal triggering at least one of the following: an acoustic signal, a visual indicator in a cabin or at the vehicle visible for the driver through the side window or side mirrors, a transmission of a warning to other systems (e.g. a vehicle electronic control unit).

The vehicle may further comprise at least one further sensor mounted on a side of the vehicle and configured to detect the object at the side of the vehicle. If so, the evaluation unit may further be configured to receive a detection signal of the further sensor as a confirmation of a presence of the (angled) object.

Optionally, the evaluation unit is configured to be placed in an idle state and an activated state. The reversing support function may be provided, e.g. only, in the activated state which is triggered by (an upcoming) engaging the reverse gear by a driver or a driving unit. The driving unit may e.g. implement a highly automated driving (HAD). Therefore, a driver may or may not be present in the vehicle during driving. The driving unit may control the reversing operation without any input from the driver (which may act only as a supervisor). The initiated or upcoming reverse gear can be sensed by corresponding sensors.

Further embodiments relate to an electronic control unit (ECU) configured to control a function of the vehicle other than reversing assistance. The ECU may include a reverse assistance device as defined before. Optionally the ECU is one of the following: a brake control unit, a light control unit, a vehicle electronic control unit, a radar control unit (i.e. the reversing assistance device may be implemented in the radar unit itself), a telematic unit.

Further embodiments relate to a vehicle with a radar unit and a reverse assistance device or an ECU as described before. Optionally, the vehicle includes a tractor and a trailer, and the radar unit is mounted at the rear of the trailer. The vehicle here may be understood as any type of motor vehicle used for transporting goods or paying passengers, e.g. long-haul transport vehicles, trucks, bus, etc.

Further embodiments relate to a method for assisting a vehicle while reversing. The vehicle comprises a radar unit mounted on a rear of the vehicle and is configured to provide distance information when approaching the object which is fully or partially behind the vehicle under an approaching angle α. The method includes obtaining, from the radar unit, the distance information to the object; determining, based on the distance information, the shortest longitudinal distance C between a corner of the rear of the vehicle and the object along the reversing direction y of the vehicle while approaching the object; and modifying distance information, based on the shortest longitudinal distance C, to compensate for the approaching angle α.

The present invention further relates to a computer-readable storage device having software instructions stored thereon, designed to carry out, when executed on a data processor, the method for assisting a vehicle when reversing as defined before.

Thus, the method may also be implemented in software or as a computer program product. The order of steps can be arbitrary as long as the desired effect is achieved. Embodiments of the present invention can, in particular, be implemented in an ECU, e.g. by software or a software module. Therefore, embodiments relate also to a computer program having a program code for performing the method, when the computer program is executed on a processor.

### BRIEF DESCRIPTION OF THE DRAWINGS

Some examples of the systems and/or methods will be described in the following by way of examples only, and with respect to the accompanying figures, in which:

FIG. 1 illustrates a reversing assistance device for a vehicle according to embodiment of the present invention.

FIG. 2 depicts the vehicle reversing toward an object partially or fully behind the vehicle under an angle.

FIG. 3 illustrates further details of a vehicle reversing toward the object under an angle according to embodiments.

FIG. 4 illustrates further details of a vehicle reversing toward an object under another angle according to embodiments.

FIG. 5 depicts a schematic communication through a communication link between different units in the vehicle.

FIG. 6 depicts schematically a flow diagram of a method for assisting a vehicle when reversing toward an object partially or fully behind the vehicle under an approaching angle.

### DETAILED DESCRIPTION OF THE DRAWINGS

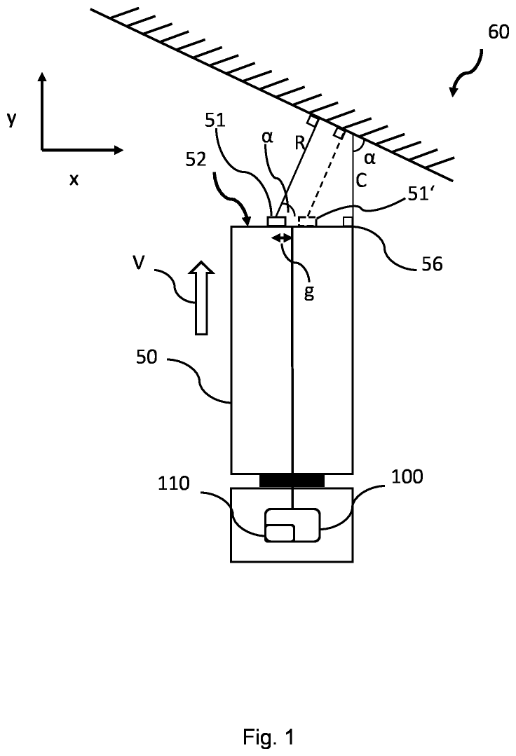

FIG. 1 depicts a reversing assistance device 100 for a vehicle 50 according to embodiments. The vehicle 50 comprises a radar unit 51 mounted on a rear 52 of the vehicle 50. The vehicle 50 is approaching an object 60 that is partially or fully behind the vehicle 50 with a speed/direction V along a reversing direction y. It is understood that the device may also be installed on the trailer, not necessarily on the tractor, or in any other control or HAD unit present in the vehicle 50.

The radar unit 51 may be mounted on the rear 52 at any position, e.g. spaced from a middle by an offset g. For example, a different radar unit 51′ can be placed at a different position (see dashed device 51′). The radar unit 51 transmits radar signals (continuous or pulsed) which are reflected at the object 60 and return subsequently to the radar unit 51. The closest distance R from the radar unit 51 to the object 60 represents the propagation path of the first return signal, which can be easily detected by the radar unit 51. The line of the closest distance R should have a rectangular angle with a surface plane of the object 60. The radar unit 51 will, in general, receive multiple return signals from additional reflections, which encode information about the geometry of the object 60.

According to embodiments, the radar unit 51 is configured to provide an angular resolution in that it provides information enabling a determination of an approaching angle α. For this, the radar unit 51 may include an antenna array or multiple transmitter and receivers that allow to measure the angle α for the first and probably strongest return signal. For example, if the radar unit 51 comprises a first radar unit 51 and a second radar unit 51′, two shortest distances R1, R2 can be determined, from where the approaching angle α can be calculated as cos

$$α = \frac{R 1 - R 2}{g} ,$$

wherein the closest distance R1 is measured by the radar unit 51, the closest distance R2 is measured by another radar unit 51′ and g is the distance between both radar units 51, 51′. According to the present notation, the angle α is greater than 0 and smaller than 180 degrees (180°>α>0).

Since the shortest or closest distance R may always be greater than zero—even if the vehicle 50 hits the object 60—this information is not reliable. Accordingly, the reversing assistance device 100 comprises an evaluation unit 110 that provides a reversing function by obtaining the distance information R, R1, R2, α from the radar unit 51 and determines a shortest longitudinal distance C. This shortest longitudinal distance C is the distance measured along the reversing direction y from a corner 56 of the vehicle rear 52 to the object 60. If the approaching angle α is smaller than 90°, left-hand corner 56 (as shown in FIG. 1) will be taken, and if the approaching angle α is larger than 90° a right-hand corner (opposite corner of the corner 56 in FIG. 1) will be taken. In any case, the determination of the shortest longitudinal distance C can be done from the corner that will hit the object when the vehicle 50 keeps reversing.

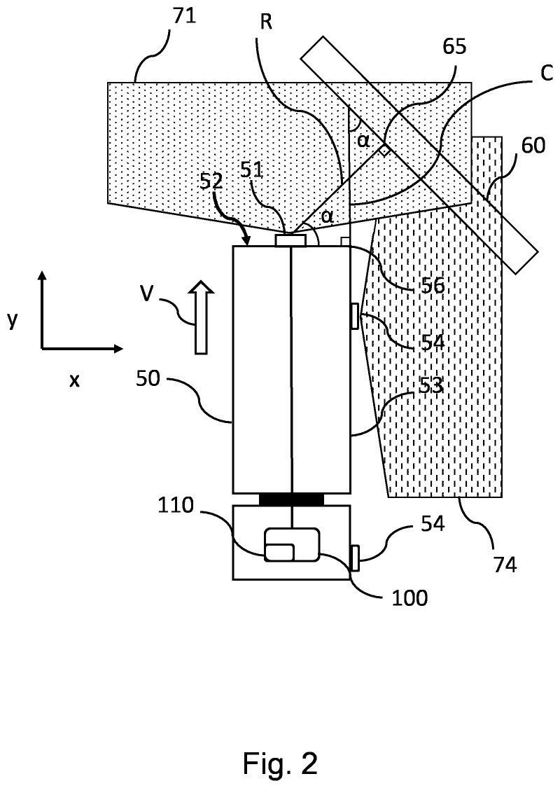

FIG. 2 depicts another embodiment for the reversing assistance device 100, where the vehicle 50 is reversing along a reversing direction y and the radar unit 51 is mounted at the vehicle rear 52 at a center position (viewed in the depicted top view). Here, the vehicle 50 comprises a trailer 53, a sensor device 54 mounted on the side of the vehicle 50, and the radar unit 51 mounted on the trailer 53. The sensor device 54 may be a camera, another radar or any other sensor that is able to capture information from the surrounding which is mounted anywhere at the side of the trailer or on towing vehicle (e.g. at a mirror).

The radar unit 51 is configured to sense objects behind the vehicle 50 in its coverage area 71. The coverage area 71 includes an area that is strictly behind the vehicle 50 which may be covered only by the radar unit 51, and an area that is behind the vehicle 50, but which can be covered by the sensor device 54, too. The sensor device 54 is configured to sense objects beside the vehicle 50 in its coverage area 74. This coverage area 74 includes an area that is strictly beside the vehicle 50 and can be sensed only by the sensor device 54 (not by the radar unit 51). In an overlapping area of both coverage areas objects can be sensed by the sensor device 54 and by the radar unit 51.

FIG. 2 further shows a reflection point 65 on the object 60 that reflects radar signals emitted from radar unit 51 on the shortest path back to the radar unit 51 (corresponding to the closest distance R).

Next, further details will be described of how, according to embodiments, the evaluation unit 110 may determine the shortest longitudinal distance C to thus enable a compensation of a non-rectangular approaching angle α.

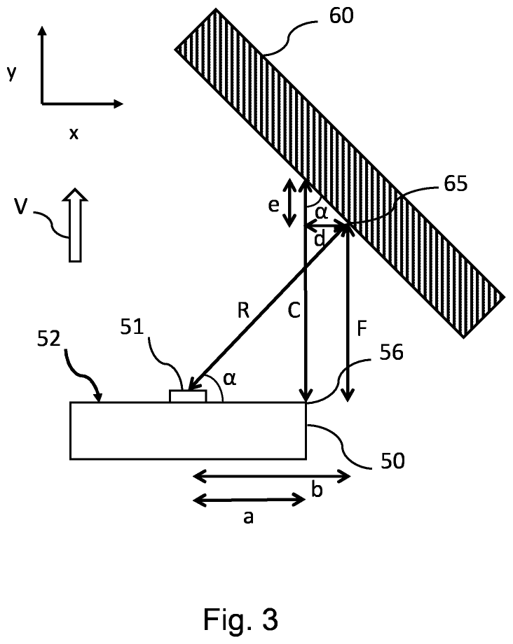

FIG. 3 illustrates several distances that may be used by embodiments to determine the shortest longitudinal distance C form the exemplary left corner 56 of the vehicle 50 to the object 60 along the reversing direction y. It should be understood, the reversing direction could also be curved for which the shortest longitudinal distance C can still be calculated. However, to keep the calculation simple, it is assumed that the vehicle 50 reverses along a straight line (y-direction).

According to embodiments, the evaluation unit 110 determines or receives (e.g. from the radar unit 51 or from another unit that receives this information from the radar unit 51) the closest distance R and the approaching angle α to the object 60. The determination may be based on multiple distances or a point cloud or even an image of the object 60 or any other information from where the closest distance R and the approaching angle α can be derived. The closest distance R is measured to the reflection point 65, which in this embodiment is not strictly behind the vehicle 50.

A distance between the corner 56 and the radar unit 51 may be known and will be denoted by “a”. The evaluation unit 110 may further be configured to determine a reflection distance F. The reflection or longitudinal distance F is a distance measured between the vehicle rear 52 and the reflection point 65 and can be calculated as: F=R×sin α.

The evaluation unit 110 may further be configured to calculate a lateral distance “b” between the radar unit 51 and the reflection point 65 by: b=R×cos α.

Furthermore, the evaluation unit 110 may be configured to determine the shortest longitudinal distance C between the corner 56 and the object 60 along the reversing direction y of the vehicle

$$50 as : C = F + e = F + ( b - a ) \times \frac{b}{F}$$

wherein “b−a” is denoted in FIG. 3 by “d”.

It is understood that this is one way of determining the shortest longitudinal distance C. A person skilled in the art can easily use other equations for the determination of the shortest longitudinal distance C. Furthermore, it is apparent that this calculation applies in the case where the approaching angle α is larger than 90°, in which case not the depicted distance “a”, but the distance from the radar unit 51 to the opposite corner will be used in the calculation. If the radar unit 51 is in the middle, both distances to the corners will be equal and the calculation does not change.

Furthermore, according to embodiments, the evaluation unit 110 may be able to compensate any offset in the position of the radar unit 51 from a default or reference position (e.g. from a middle line of the vehicle 50). The corresponding information about the mounting position may be stored in the radar unit 51 or in the evaluation unit 110 or may be obtained from any storage device in the vehicle 50. It is understood that the mounting position of the radar unit 51 can be arbitrary, i.e. the offset may relate to any spatial direction. According to embodiments, this information is known (e.g. there is a predetermined mounting position) and will be taken into account when determining the shortest longitudinal distances C. Hence, the offset can be compensated.

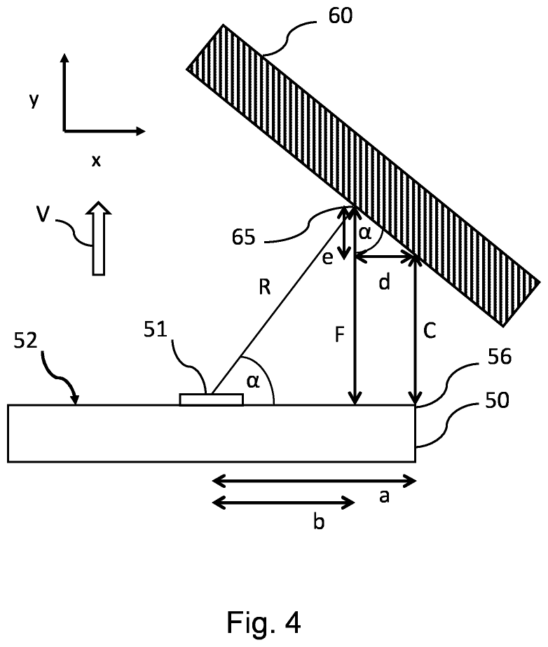

FIG. 4 depicts an exemplary vehicle 50 reversing toward the object 60 under a larger approaching angle α so that the reflection point 65 is here strictly behind the vehicle 50. All other features are implemented as in the embodiments described before. Therefore, the known distance between the corner 56 and the radar unit 51 can again be denoted by “a” and the evaluation unit 110 may be configured to determine a reflection distance F as a longitudinal distance between the rear 52 and the reflection point 65 and calculated according to equation (1). It may further be configured to determine a lateral distance b according to equation (2) and to determine the shortest longitudinal distance C by equation (3), wherein the value: e=b−a is now negative.

From the situation depicted in FIG. 4 it is further apparent the value of the closest distance R obtained from the radar unit 51 differs from the actual shortest longitudinal distance C (it is longer). There is an immediate risk of collision when the driver or the driving unit would rely on the information.

The vehicle 50 may also include a driving unit that implements a highly automated driving (HAD). Therefore, a driver may or may not be present in the vehicle during driving and the driving unit may control the reversing operation without any input from the driver (who may act only as a supervisor). Hence, the reversing assistance device 100 helps not only a driver of the vehicle 50, but may also assist a driving unit, based on the shortest longitudinal distance information C information, to more accurately and reliably assess of the actual situation.

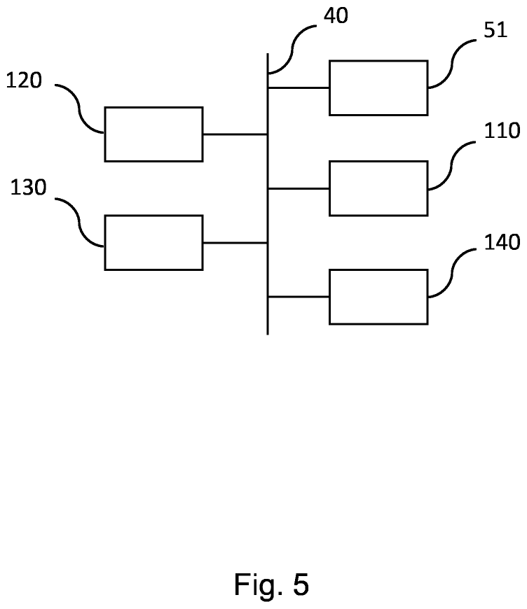

FIG. 5 depicts a schematic diagram of different units of a vehicle 50 connected to each other via a communication link such as a controller area network, CAN bus 40, or ethernet or another data communication infrastructure. The vehicle 50 may comprise various control units such as a vehicle control unit 140 or a central control unit, a light control unit 130 to control the light indicators, a brake control unit 120, and a control unit integrated in the radar unit 51. The evaluation unit 110 can be in communication with all these control units via the exemplary CAN bus 40 and/or via wireless or via any radio communication to exchange data.

However, according to embodiments, the evaluation unit 110 may be integrated in one these control units, i.e. in the radar unit 51 or in the braking unit 120, or in the light control unit 130 or in the central unit 140. In particular, integration may mean that no additional component has to be added to the vehicle. In other words, after integration of the evaluation unit 110 into a given control unit, both components cannot be separated from each other. All functions of the evaluation unit 110 can be implemented into the given control unit by installing respective software.

Therefore, embodiments relate also to an electronic control unit, ECU, including the reversing assistance device 100. The electronic control unit ECU is then configured to control a dedicated function (e.g. braking, lights) of the vehicle 50 and, in addition, the reversing assistance. For example, if the reversing assistance device 100 is integrated into the brake control unit 120, it will control the vehicle braking as well as provides the reversing function.

According to further embodiments, the evaluation unit 110 may further be configured to be placed in an idle state and an activated state. The evaluation unit 110 may provide the reversing support function only in the activated state. The activated state may be triggered by engaging a reverse gear by the driver and/or by a driving unit. Similarly, the evaluation unit 110 may be triggered to be in the idle state when no reverse gear is engaged (by engaging a forward gear and/or parking gear) by the driver and/or driving unit.

The evaluation unit 110 according to embodiments, may further be configured to determine a speed V of the vehicle 50 and an acceleration of the vehicle 50. The evaluation unit 110 may be further configured to be in communication with internal sensors of the vehicle to obtain the speed V of the vehicle and the acceleration of the vehicle 50. Therefore, the actual reversing speed may be taken into account, for example, for a warning of an imminent collision.

For example, according to the embodiments, the evaluation unit 110 is configured to issue a signal to the driver or the driving unit, in case the determined shortest longitudinal distance C is shorter than a predefined threshold (e.g. 2 meters, 1 meter or less). The predefined threshold may be calculated by the evaluation unit 110 based on a speed V of the vehicle 50 and/or distance information obtained from the radar unit 51. The predefined threshold may be obtained from a control unit of the vehicle 50.

According to the embodiments, the issued signal by the evaluation unit 110 may trigger at least one of the following: an acoustic signal, a blinking marker, a visual indicator in a cabin or visible through a window or mirror, an (electric) transmission of a warning to other systems (any vehicle ECU). The issued signal may have different intensity (e.g. loudness of the acoustic signal or the frequency of the blinking end-outline marker etc.) in relation with the value of the shortest longitudinal distance C.

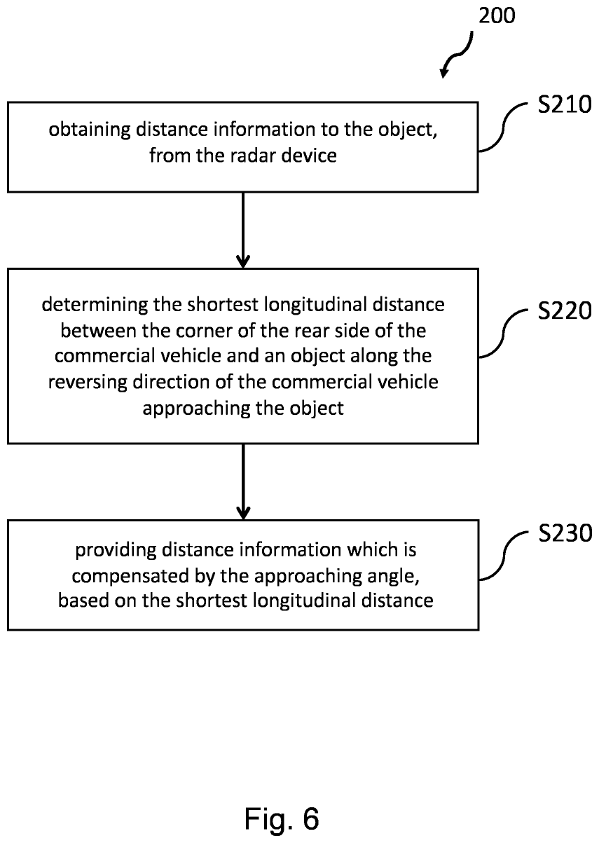

FIG. 6 depicts a flow diagram of a method 200, for assisting a vehicle 50 reversing. The vehicle 50 comprising the at least one radar unit 51 mounted on the rear 52 of the vehicle 50 and configured to provide distance information R, α when approaching an object 60 fully or partially behind the vehicle 50 under an approaching angle α. The method comprises the steps of: obtaining S210 distance information R, α to the object 60 from the radar unit 51; determining S220 a shortest longitudinal distance C between the corner 56 of the vehicle 50 and the object 60 along the reversing direction y of the vehicle 50 approaching the object 60 based on the distance information R, α; and providing S230 distance information which is compensated by the approaching angle α, based on the shortest longitudinal distance C.

The method 200 may further comprise determining at least one of the following: a speed of the vehicle 50, an acceleration of the vehicle 50, the approaching angle α, a reflection distance F, a lateral distance b.

The method 200 may also be a computer-implemented method. A person of skill in the art would readily recognize that steps of various above-described methods may be performed by programmed computers. Embodiments are also intended to cover program storage devices, e.g., digital data storage media, which are machine or computer-readable and encode machine-executable or computer-executable programs of instructions, wherein the instructions perform some or all of the acts of the above-described methods when executed on the computer or processor.

The description and drawings merely illustrate the principles of the disclosure. It will thus be appreciated that those skilled in the art will be able to devise various arrangements that, although not explicitly described or shown herein, embody the principles of the disclosure and are included within its scope.

Furthermore, while each embodiment may stand on its own as a separate example, it is to be noted that in other embodiments the defined features can be combined differently, i.e. a particular feature descripted in one embodiment may also be realized in other embodiments. Such combinations are covered by the disclosure herein unless it is stated that a specific combination is not intended.

### LIST OF REFERENCE SIGNS

50 vehicle
51 distance measurement device
51 radar unit
52 rear of the vehicle
53 trailer
54 sensor devices
56 (rear) corner of the vehicle
60 object
65 reflection point
71 coverage area of the radar unit
74 coverage area of the other sensor(s)
100 reversing assistant device
110 evaluation unit
120 breaking control unit
130 light control unit
140 vehicle electronic control unit
α approaching angle
a distance between radar unit and the rear corner of the vehicle
b lateral distance between the radar unit and the reflection point
C shortest longitudinal distance
d distance between a and b
e distance between C and F
F longitudinal distance between the rear of the vehicle and the reflection point
R closest distance between radar unit and the object
V speed/direction of moving of the vehicle
x lateral direction (perpendicular to the driving direction)
y longitudinal direction (e.g. driving direction)

1.-11. (canceled)

12. A reversing assistance device for a vehicle, comprising:
a radar unit mounted on a rear of the vehicle, configured to provide distance information to an object that is fully or partially behind the vehicle when approaching the object under an approaching angle, and
an evaluation unit configured to provide a reversing support function by:
obtaining from the radar unit the distance information to the object;
determining, based on the distance information, a shortest longitudinal distance between a corner of the rear of the vehicle and the object along a reversing direction of the vehicle; and
modifying the distance information to compensate for the approaching angle based on the shortest longitudinal distance.

13. The device according to claim 12, wherein the evaluation unit is further configured to at least one of, determine and transmit to other systems, at least one of the following:
the approaching angle;
a closest distance between the radar unit and a reflection point on the object;
a longitudinal distance between the rear of the vehicle and the reflection point on the object, measured along reversing direction, by using the formula: F=R×sin α, wherein F is the longitudinal distance, R is the closest distance and α the approaching angle;
a lateral distance between the radar unit and the reflection point, measured along a lateral direction, by using the formula: b=R×cos α, wherein b is the lateral distance;
a shortest longitudinal distance, by using the formula: C=F+(b−a)×b/F, wherein C is the shortest longitudinal distance, a is a distance from the radar unit to a rear corner of the vehicle; and
a compensation for an offset of a position of the radar unit from a reference position.

14. The device according to claim 12, wherein the vehicle is operated by at least one of, a driver and a driving unit, and the evaluation unit is further configured to issue a signal to at least one of the driver or the driving unit, in response to the determined shortest longitudinal distance being shorter than a threshold.

15. The device according to claim 12, wherein the evaluation unit is further configured to issue an alert signal triggering at least one of the following:
an acoustic signal;
a visual indicator in at least one of a cabin or on the vehicle visible for the driver through at least one of the side window and side mirrors; and
a transmission of a warning to other systems.

16. The device according to claim 12, wherein the vehicle further comprises at least one further sensor, mounted on a side of the vehicle and configured to detect the object at the side of the vehicle, wherein the evaluation unit is further configured to receive a detection signal of the further sensor as a confirmation of a presence of the object.

17. The device according to claim 12, wherein the device is an electronic control unit configured to control a function of the vehicle, other than reversing assistance.

18. The device according to claim 17, wherein the electronic control unit is one of the following: a brake control unit; a light control unit; a vehicle electronic control unit; a radar control unit; and a telematic unit.

19. The device according to claim 12, wherein the vehicle includes a trailer and the radar unit is mounted on the rear of the trailer.

20. A method for assisting a vehicle while reversing, the vehicle comprising a radar unit mounted on a rear of the vehicle and configured to provide distance information when approaching the object which is fully or partially behind the vehicle under an approaching angle, wherein the method comprises:
obtaining distance information to the object from the radar unit;
determining, based on the distance information, the shortest longitudinal distance between a corner of the rear of the vehicle and the object along the reversing direction of the vehicle while approaching the object; and
modifying distance information, based on the shortest longitudinal distance, to compensate for the approaching angle.

21. The method according to claim 20, wherein a computer-readable storage device having software that is stored thereon and the software is executed by a data processing unit which performs the method.
